(19) United States
(12) Patent Application Publication
(10) Pub. No.: US 2015/0297986 A1
(43) Pub. Date: Oct. 22, 2015

(54) SYSTEMS AND METHODS FOR INTERACTIVE VIDEO GAMES WITH MOTION DEPENDENT GESTURE INPUTS

(71) Applicant: Aquifi, Inc., Palo Alto, CA (US)

(72) Inventors: Carlo Dal Mutto, Sunnyvale, CA (US); Francesco Peruch, Sunnyvale, CA (US); Ahmed Tashrif Kamal, San Jose, CA (US)

(21) Appl. No.: 14/690,287

(22) Filed: Apr. 17, 2015

Related U.S. Application Data
(60) Provisional application No. 61/981,607, filed on Apr. 18, 2014.

(51) Int. Cl. A63F 13/213; A63F 13/5258; A63F 13/56

(52) U.S. Cl. CPC A63F 13/213; A63F 13/56; A63F 13/5258

(57) ABSTRACT

A method for providing a user interface for a computing device includes receiving, by a processor, video data from a camera system; detecting, by the processor, a first gesture from the video data; receiving, by the processor, motion data from a motion sensor, the motion data corresponding to the motion of the camera system; determining, by the processor, whether the motion data exceeds a threshold; ceasing detection of the first gesture when the motion data exceeds the threshold; and supplying, by the processor, the detected first gesture to an application as first input data when the motion data does not exceed the threshold.

### CROSS-REFERENCE TO RELATED APPLICATION(S)

This application claims the benefit of U.S. Provisional Patent Application No. 61/981,607, titled “Interactive Video Games with Motion Dependent Gesture Inputs,” filed in the United States Patent and Trademark Office on Apr. 18, 2014, the entire disclosure of which is incorporated herein by reference.

### BACKGROUND

Camera and other motion sensing devices are now being used as user interface devices for computing devices. For example, a screen unlock feature may be used when a front facing camera detects and recognizes the face of an authorized user. As another example, the Microsoft® Kinect® controller enables detection of user motions, which can be used to interact with video games.

Many current computing devices also include cameras that are oriented to image a user during normal use of those devices. Such “front facing” cameras are generally used for video conferencing or in circumstances where a user may wish to take a picture of himself or herself.

### SUMMARY

Aspects of embodiments of the present invention are directed to systems and methods for providing a computing device having a user interface with motion dependent inputs.

According to one embodiment of the present invention, a computing system includes: a camera system; a motion sensor rigidly coupled to the camera system; and a processor and memory, the memory storing instructions that, when executed by the processor, cause the processor to: receive video data from the camera system; detect a first gesture from the video data; receive motion data from the motion sensor, the motion data corresponding to motion of the camera system; determine whether the motion data exceeds a threshold; cease detecting the first gesture from the video data when the motion data exceeds the threshold; and supply the detected first gesture to an application as first input data when the motion data does not exceed the threshold.

The memory may further store instructions that, when executed by the processor, cause the processor to: supply the motion data as the first input data to the application when the motion data exceeds the threshold.

The memory may further store instructions that, when executed by the processor, cause the processor to: estimate background motion in accordance with the motion data; and compensate the video data based on the motion data to generate compensated video data, wherein the computing system is configured to detect the first gesture from the video data based on the compensated video data.

The computing system may further include a display interface; and the memory may further store instructions that, when executed by the processor, cause the processor to display, via the display interface, a user interface, the user interface including a silhouette generated from the camera system, the silhouette representing the detected first gesture.

The silhouette may be blended with the user interface using alpha compositing.

The silhouette may include a plurality of silhouettes, each of the silhouettes corresponding to a portion video data captured at a different time.

The memory may further store instructions that, when executed by the processor, cause the processor to: cease detecting the first gesture when the application is inactive; measure environmental conditions when the application is inactive; and adjust parameters controlling the camera system when the application is inactive.

The memory may further store instructions that, when executed by the processor, cause the processor to: detect a second gesture from the video data concurrently with detecting the first gesture; and supply the detected second gesture to the application as second input data.

The silhouette may include a plurality of silhouettes, a first silhouette of the silhouettes representing the detected first gesture and a second silhouette of the silhouettes representing the detected second gesture.

The application may be a video game.

According to one embodiment of the present invention, a method for providing a user interface for a computing device includes receiving, by a processor, video data from a camera system; detecting, by the processor, a first gesture from the video data; receiving, by the processor, motion data from a motion sensor, the motion data corresponding to the motion of the camera system; determining, by the processor, whether the motion data exceeds a threshold; ceasing detection of the first gesture when the motion data exceeds the threshold; and supplying, by the processor, the detected first gesture to an application as first input data when the motion data does not exceed the threshold.

The method may further include: supplying the motion data as the first input data to the application when the motion data exceeds the threshold,

The method may further include: estimating background motion in accordance with the motion data; and compensating the video data based on the motion data to generate compensated video data, wherein the detecting the first gesture from the video data is performed by detecting the first gesture from the compensated video data.

The method may further include: displaying, by the processor via a display interface, a user interface including a silhouette generated from the camera system, the silhouette representing the detected first gesture.

The silhouette may be blended with the user interface using alpha compositing.

The silhouette may include a plurality of silhouettes, each of the silhouettes corresponding to a portion of the video data captured at a different time.

The method may further include: ceasing detecting the first gesture when the application is inactive; measuring environmental conditions when the application is inactive; and adjusting parameters controlling the camera system when the application is inactive.

The method may further include: detecting a second gesture from the video data concurrently with detecting the first gesture from the video data; and supplying the detected second gesture to the application as second input data.

The silhouette may include a plurality of silhouettes, a first silhouette of the silhouettes representing the detected first gesture and a second silhouette of the silhouettes representing the detected second gesture.

The application may be a video game.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a schematic block diagram of a computing system in accordance with an embodiment of the invention.

FIG. 1B is a schematic block diagram of a computing system in accordance with an embodiment of the invention.

FIG. 2 is a flowchart illustrating a method for responding to gesture inputs observed in video data captured by a camera system and motion inputs detected using motion sensors in accordance with an embodiment of the invention.

FIG. 3 is a screen shot of video game interface incorporating a silhouette overlay of a gesturing hand generated using video data captured by a computing system in accordance with an embodiment of the invention.

FIG. 4 is a flowchart illustrating a method for adjusting camera parameters during an inactive period according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Some aspects of embodiments of the present invention are directed to systems and methods for providing a user interface with motion dependent inputs. According to some aspects, embodiments of the present invention allow a user to interact with a program, such as a video game, by making gestures in front of a camera integrated into (or rigidly attached to) a computing device such as a mobile phone, tablet computer, game console, or laptop computer. The computing device may use computer vision techniques to analyze video data captured by the camera to detect the gestures made by the user. Such gestures may be made without the user's making physical contact with the computing device with the gesturing part of the body (e.g., without pressing a button or touching a touch sensitive panel overlaid on a display).

However, the motion of the computing device itself (and its integrated or rigidly attached camera) can complicate computer vision based interaction techniques. From only a series of frames acquired by a standard camera, it is very hard to distinguish the motion of the camera in the scene from the motion in the scene itself.

Existing methods for motion analysis and motion compensation on images acquired by a standard camera are known in the field of computer vision, but are very computationally expensive and therefore may be unsuited for providing real-time interaction in low power conditions, such as a mobile device operating on a battery.

As such, aspects of embodiments of the present invention are directed to systems and methods for analyzing the motion of the device and using the analyzed motion to improve the user experience in gesture-powered applications (such as video games) running on computing devices. Aspects of embodiments of the present invention are directed to systems and methods for providing user interfaces for video games that respond to gesture inputs observed in video data acquired using at least one camera when the computing system is detected not to be moving (e.g., when the computing system is detected to be still).

Aspects of embodiments of the present invention will be described below with respect to video game systems. However, embodiments of the present invention are not limited thereto and may be applicable to providing a gesture based user interface for general purpose computing devices running video games or other (non-video game) software. Examples of video game systems include mobile phones, tablet computers, laptop computers, desktop computers, standalone game consoles connected to a television or other monitor, etc.

In several embodiments, a video game system utilizes a game engine to generate a user interface that responds to user inputs including gesture inputs observed in video data acquired using a camera system. In many embodiments, the video game system detects user inputs by analyzing sequences of frames of video captured by the camera system to detect motion. In a number of embodiments, motion is detected by observing pixels that differ from one frame to the next by a threshold (or a predetermined threshold). In several embodiments, motion is detected in an encoded stream of video output by a camera system by observing motion vectors exceeding a threshold magnitude (e.g., a predetermined threshold magnitude) with respect to blocks of pixels exceeding a threshold size (e.g., a predetermined size). When motion is detected, a silhouette of the moving object is blended with the user interface of the video game to provide visual feedback.

As discussed above, motion of the camera system can create the appearance of motion in the captured images due to the translation of what would otherwise be a static scene (e.g., the static background). In several embodiments, the video game system includes one or more sensors, such as accelerometers, configured to detect motion of the camera system (or motion of the video game system or video game controller in embodiments where the video game system or video game controller is rigidly coupled to the camera system). When a motion is less than a threshold value, then the gestures detected in the video data stream are used as a first input modality. When motion exceeding the threshold (e.g., a predetermined threshold) is detected, the video game system can cease accepting inputs from the video data stream and can receive input via a secondary input modality such as (but not limited to) the motion of the video game system. In a number of embodiments, the user can choose between providing inputs via gesture based interactions and via moving (e.g., tilting or shaking) the video game system or the video game controller. In several embodiments, motion data obtained from the sensors can be utilized to estimate background motion in motion data captured by the camera system and the motion compensated video data utilized to detect gestures.

For example, in a video game according to one embodiment, whenever some motion of the video game system or controller is detected, the video game enters an “earthquake” mode, in which the motion of a player controlled character relative to the scene is controlled by the amount of motion registered by one or more of the motion sensors.

### System Architecture

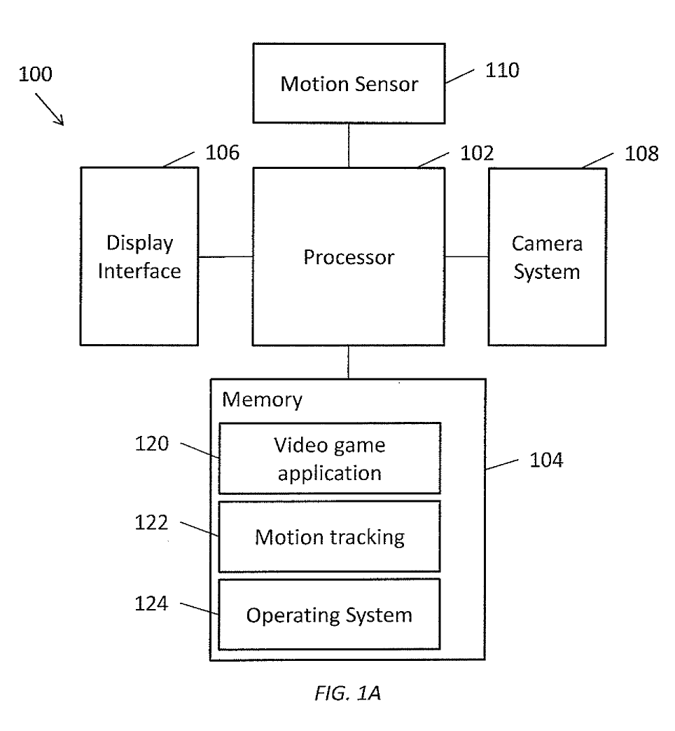

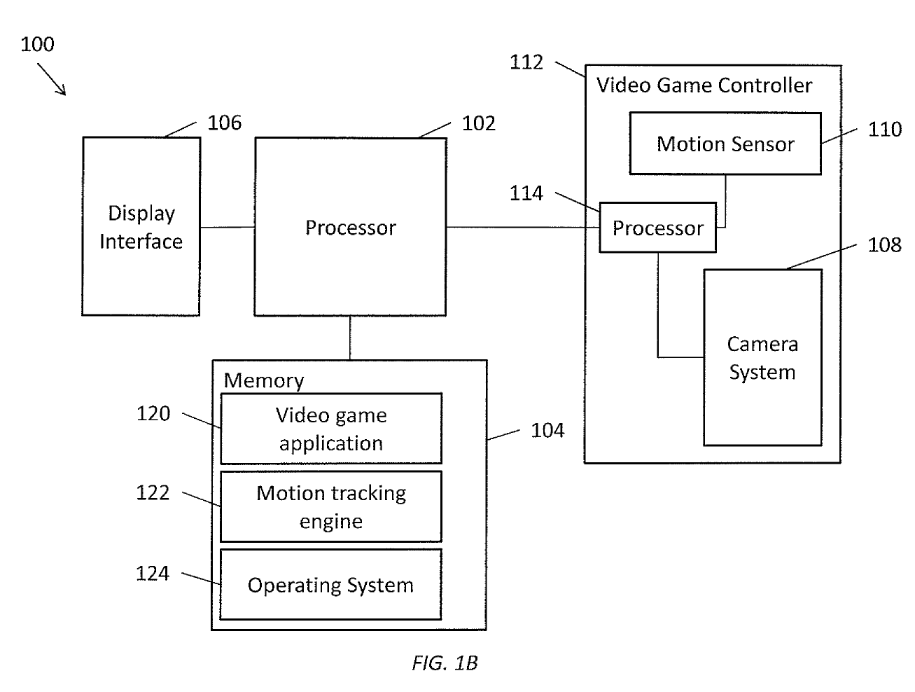

Turning now to the drawings, a video game system in accordance with an embodiment of the invention is illustrated in FIG. 1A. The video game system 100 includes a processor 102 configured by machine readable instructions stored in memory 104. The video game system also includes a display interface 106 that can be coupled to a display, where the display can be integrated within the video game system 100 and/or external to the video game system, and a camera system 108 configured to capture images of at least a portion of a user viewing the display using at least one camera. As is discussed further below, the camera system 108 can be utilized to obtain frames of video that capture gesture inputs provided by a user. In several embodiments, the video game system 100 includes at least one motion sensor 110 such as (but not limited) to a set of accelerometers or a set of gyroscopes. The motion sensor(s) 110 are configured to detect motion and provide signals to the processor 102 indicating that motion is detected and/or the extent of the motion.

In some embodiments, the components of the video game system 100 are rigidly integrated, such as in a mobile phone, tablet computer, laptop computer, or handheld portable gaming system. In such circumstances, the user may also hold the entire video game system 100 during typical use.

FIG. 1B is a schematic block diagram of a computing system in accordance with another embodiment of the invention where the camera system 108 and the motion sensor 110 are be located in a video game controller 112 (or other user input device) connected to the processor via a wired connection (e.g., a flexible cable) or a wireless connection, where the user holds the video game controller 112 to supply inputs to the video game system 100. In some embodiments of the present invention, the video game controller 112 also includes a processor 114 that is configured to perform one or more of the functions described in more detail below.

In the embodiments illustrated in FIGS. 1A and 1B, the memory 104 contains a video game application (or other application) 120, a motion tracking engine (e.g., a motion tracking driver or motion tracking software library) 122, and an operating system 124. The video game application 120 configures the processor 102 to render a video game interface on a display via the display interface 106. In many embodiments, the motion tracking engine 122 configures the processor 102 to determine whether the video game system 100 of FIG. 1A (or the video game controller 112 of FIG. 1B) is in motion.

In some embodiments of the present invention, the motion tracking engine 122 is implemented as a software library or module that may be linked or embedded into a video game application. In other embodiments of the present invention, the motion tracking engine 122 is implemented as a device driver configured to control and receive data from one or more of the camera system 108 and the motion sensor 110. The motion tracking engine 122 provides an application programming interface (API) that may be accessed by the video game application 120 in order to receive processed user inputs corresponding to the detected gestures and/or detected motion of the video game system 100 or the video game controller 112. In some embodiments, the motion tracking engine 122 is provided as software separate from the video game application and the same motion tracking engine 122 may be used by different video game applications 120 (e.g., as a shared library). In some embodiments of the present invention, the motion tracking engine 122 is a component of a software development kit (SDK) that allows software developers to integrate motion and gesture based input into their own applications 120.

In some embodiments of the present invention, the motion tracking engine 122 is implemented, at least in part, in a hardware device such as a field programmable gate array (FPGA), an application specific integrated circuit (ASIC), or a processor coupled to memory storing instructions that, when executed by the processor, cause the processor to perform functions of the motion tracking engine 122.

When the video game system 100 (or the video game controller 112) is moving, the processor 102 can analyze the motion data received from the motion sensor 110 to detect motion based user inputs that are provided to the video game application 120, which updates the video game interface via the display interface 106 in response to the motion based inputs.

When the video game system 100 (or the video game controller 112) is stationary and/or subject to movement below a threshold (e.g., a predetermined threshold), the motion tracking engine 122 can configure the processor 102 to analyze video data captured by the camera system 108 to detect gesture based inputs that can be provided to the video game application 120, which updates the video game interface on the display via the display interface 106 in response to the gesture based inputs. In several embodiments, the motion tracking application 120 generates a silhouette based upon the outline of the object (e.g. hand, head, device) observed as providing a gesture input. In a number of embodiments, the video game application 120 overlays the silhouette on the video game interface to provide visual feedback that the gesture inputs are being detected.

In certain embodiments, the camera system 108 continues to capture video data when the video game system 100 is in motion. In other embodiments, power is conserved by suspending capture of video data by the camera system 108 during periods in which detected motion exceeds a threshold.

In many embodiments, the processor 102 receives frames of video data from the camera system 108 via a camera interface. The camera interface can be any of a variety of interfaces appropriate to the requirements of a specific application including (but not limited to) the USB 2.0 or 3.0 interface standards specified by USB-IF, Inc. of Beaverton, Oreg., and the MIPI-CSI2 interface specified by the MITI Alliance. In a number of embodiments, the received frames of video data include image data represented using the RGB color model represented as intensity values in three color channels. In several embodiments, the received frames of video data include monochrome image data represented using intensity values in a single color channel. In several embodiments, the image data represents visible light. In other embodiments, the image data represents intensity of light in non-visible portions of the spectrum including (but not limited to) the infrared near-infrared and ultraviolet portions of the spectrum. In certain embodiments, the image data can be generated based upon electrical signals derived from other sources including but not limited to ultrasound signals, time of flight cameras, and structured light cameras. In several embodiments, the received frames of video data are compressed using the Motion JPEG video format (ISO/IEC JTC1/SC29/WG10) specified by the Joint Photographic Experts Group. In a number of embodiments, the frames of video data are encoded using a block based video encoding scheme such as (but not limited to) the H.264/MPEG-4 Part 10 (Advanced Video Coding) standard jointly developed by the ITU-T Video Coding Experts Group (VCEG) together with the ISO/IEC JTC1 Motion Picture Experts Group. In certain embodiments, the processor 102 receives RAW image data.

In several embodiments, the camera system 108 that captures the image data also captures depth maps and the processor 102 is configured to utilize the depth maps in processing the image data received from the at least one camera system. In several embodiments, the camera systems 108 include components for capturing and generating depth maps including (but not limited to) time-of-flight cameras, multiple cameras (e.g., cameras arranged with overlapping fields of view to provide a stereo view of a scene), and active illumination systems (e.g., components for emitting structured or coded light).

In many embodiments, the processor 102 uses the display interface 106 to drive the display. In a number of embodiments, the High Definition Multimedia Interface (HDMI) specified by HDMI Licensing, LLC of Sunnyvale, Calif. is utilized to interface with the display device. In other embodiments, any of a variety of display interfaces appropriate to the requirements of a specific application can be utilized.

As can readily be appreciated, video game systems in accordance with many embodiments of the invention can be implemented on mobile phone handsets, tablet computers, and handheld gaming consoles configured with appropriate software. Furthermore, the processor 102 referenced above can be multiple processors, a combination of a general processing unit and a graphics coprocessor or Graphics Processing Unit (GPU), and/or any combination of computing hardware capable of implementing the processes outlined below. In other embodiments, any of a variety of hardware platforms can be utilized to implement video gaming systems as appropriate to the requirements of specific applications.

### Process for Rendering Interactive Video Games

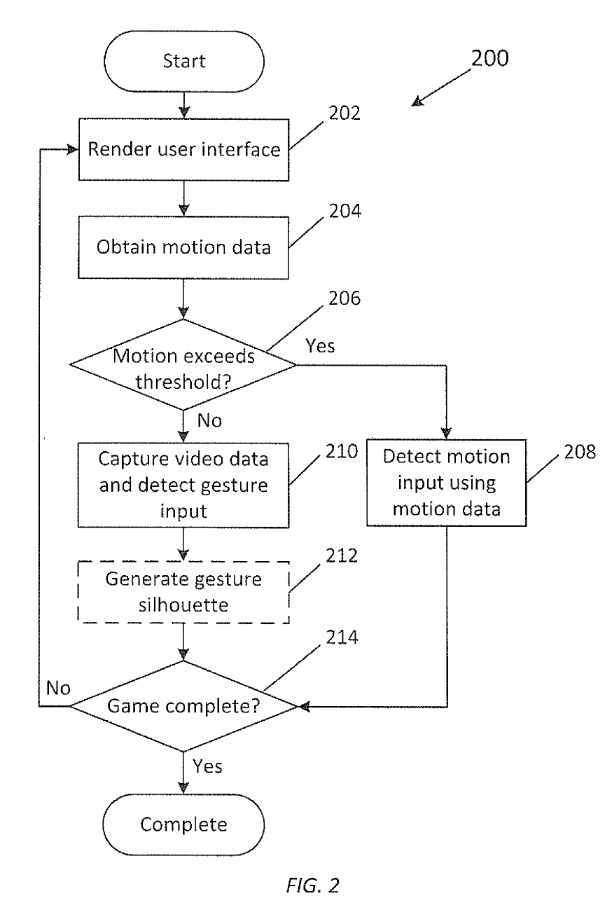

A process for providing a video game that responds to gesture inputs observed in video data acquired using at least one camera when the video game system 100 (or the video game controller 112) is detected not to be moving in accordance with an embodiment of the invention is illustrated in FIG. 2. The process 200 can be implemented by a motion tracking engine 122 running on a video game system 100 (e.g., executed by the processor 102 of the video game system 100) and includes rendering (202) a user interface via the display interface 106, obtaining (204) motion data from the motion sensor 110, and determining (206) whether the motion of the video game system 100 (or the video game controller 112) exceeds a threshold (e.g., a predetermined threshold). When the motion of the video game system 100 (or the video game controller 112) exceeds the threshold, the motion data is analyzed to detect (208) motion inputs.

When the motion of the video game system 100 (or the video game controller 112) is below the threshold, then the system captures (210) video data from the camera system 108 and detects gesture inputs in the video data, as described in more detail below. In some embodiments, a detected three dimensional gesture input (e.g., three dimensional motions made by a user) can be mapped to an event supported by the operating system 124 such as (but not limited to) a 2D touch event in order to drive interaction with (but not limited to) the video game engine of the application 120.

In some embodiments, motion data from the motion sensor 110 is utilized to estimate device motion (e.g., motion of the camera system 108) and the estimated device motion is used to compensate for expected background motion in the captured video data. In this way, background motion due to movement of the device can be disregarded (e.g., subtracted) in the detection of gesture inputs from captured video data.

In a number of embodiments, gesture inputs can be detected in operation 210 by identifying moving portions of a captured frame. Moving portions can be identified by comparing frames in a sequence of frames to detect pixels with intensities that differ by more than a threshold amount (e.g., a predetermined threshold amount). Moving portions of a frame can also be detected in encoded video based upon the motion vectors of blocks of pixels within a frame encoded with reference to one or more frames. In a number of embodiments, moving blocks of pixels are detected and blocks of pixels can be tracked to the left, right, up, and down (e.g., tracked within a plane).

In several embodiments, processes that detect optical flow can be utilized to detect motion and direction of motion toward and/or away from the camera system. In several embodiments, motion detection is offloaded to motion detection hardware in video encoders implemented within the video game system. In several embodiments, the techniques disclosed in U.S. Pat. No. 8,655,021 entitled “Systems and Methods for Tracking Human Hands by Performing Parts Based Template Matching Using Images from Multiple Viewpoints” to Dal Mutto et al. are utilized to detect 3D gestures. The disclosure of U.S. Pat. No. 8,655,021 is hereby incorporated by reference in its entirety.

In a number of embodiments, the system commences tracking upon detection of an initialization gesture. Processes for detecting initialization gestures are disclosed in U.S. Pat. No. 8,615,108 entitled “Systems and Methods for Initializing Motion Tracking of Human Hands” to Stoppa et al., the disclosure of which is incorporated by reference herein in its entirety.

In several embodiments, the motion detection engine 122 is configured to detect static gestures using any of a variety of detection techniques including (but not limited to) template matching, and/or skeleton fitting and non-skeleton-based techniques. In other embodiments, any of a variety of hardware and/or software processes can be utilized in the detection of 3D static and/or dynamic gesture inputs from video data in accordance with embodiments of the invention. Such techniques include, for example, motion, motion direction, blob tracking, and silhouette detecting techniques.

For example, in a blob tracking technique, the processor 102 identifies moving parts at each frame. The processor then associates such moving parts by means of spatial proximity and appearance analysis (e.g., Histograms of Colors or Histograms of Oriented Gradients). Association algorithms can be based on heuristics or on probabilistic approaches such as the Probabilistic Data Association Filter. In addition, proximity analysis might be augmented by means of motion analysis such as dense or sparse optical flow algorithms.

In some embodiments of the present invention hardware implementations of the algorithms are used to improve performance. For instance, in the case of motion analysis, it is possible to avoid off-load the computation of motion-vectors to a hardware-implemented video codec, such as the motion computation module in an H.264 encoder, which is generally available and highly optimized in processors typically found on a mobile device.

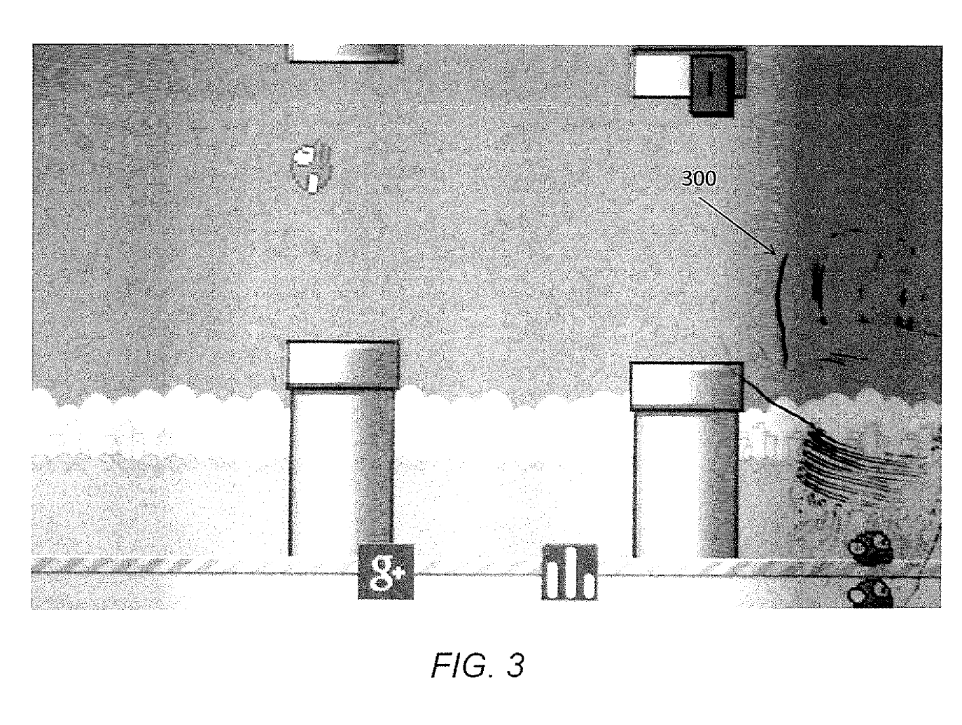

Referring again to FIG. 2, captured video data used to detect gesture inputs can also be used to provide visual feedback to the user that a gesture input is detected. In a number of embodiments, a silhouette is generated (212) using the video data and overlaid on the user interface rendered by the video game system 100. An example of a silhouette 300 generated using video data showing a gesturing hand overlaid on a video game interface in accordance with an embodiment of the invention is illustrated in FIG. 3.

In several embodiments, a silhouette can be computed using techniques including (but not limited to) temporal reasoning, spatial gradient analysis, spatia-temporal analysis, morphological operators, and/or object-detection techniques. In many embodiments, temporal reasoning is utilized to detect the difference between an image acquired at the current frame and an image acquired in a previous frame. Differences can be thresholded and/or binarized (quantized). In certain embodiments, comparisons can be generated over multiple previous frames and each frame contributed can be displayed with grayscale coding (differences between more recent frames can be brighter than differences with older frames).

In several embodiments, silhouettes can be represented in all of the RGB channels of a display or on a subset of the color channels. In various embodiments, alpha compositing is utilized to enhance the results. In addition, in various embodiments, the silhouettes are displayed to have different appearances based on whether or not a gesture has been detected or based on the gesture was detected. For example, the silhouettes may be displayed in gray when no gesture is detected, displayed in green when a first gesture is detected, and displayed in blue when a second, different gesture is detected. Although specific techniques for providing visual feedback concerning gesture detection are disclosed above with respect to FIGS. 2 and 3, any of a variety of techniques can be utilized based upon using captured video data to drive visual feedback via a user interface of a video game system in accordance with embodiments of the invention.

Referring again to the process 200 illustrated in FIG. 2, the process repeats until a determination (214) is made that the video game is complete (e.g., the application 120 has been exited or a level or round of the game is complete). Although specific processes are described above with reference to FIG. 2, any of a variety of processes can be utilized to provide a video game that responds to gesture inputs observed in video data acquired using at least one camera when the video game system is detected not to be moving as appropriate to the requirements of specific applications in accordance with an embodiment of the invention.

In many embodiments, the motion tracking engine 122 serves to filter false positive gesture detections by selectively accepting gesture inputs according to game status. In a number of embodiments, a gesture detection process can be aware of the game status in order to restrict the domain of gestures that can be detected at a given time to a vocabulary of gestures appropriate to the state of the game.

In a number of embodiments, camera parameters of the camera system 108 are opportunistically set based on application state. For example, during inactive periods of the game before a user begins to interact with the game using the gesture detection interface (e.g., while loading game data, between playing rounds, when the game is paused, when the game is in a configuration mode, etc.), the motion tracking engine 122 can determine appropriate image capture parameters for performing gesture detection (e.g. setting exposure, white balance calibration, active illumination power level, etc.).

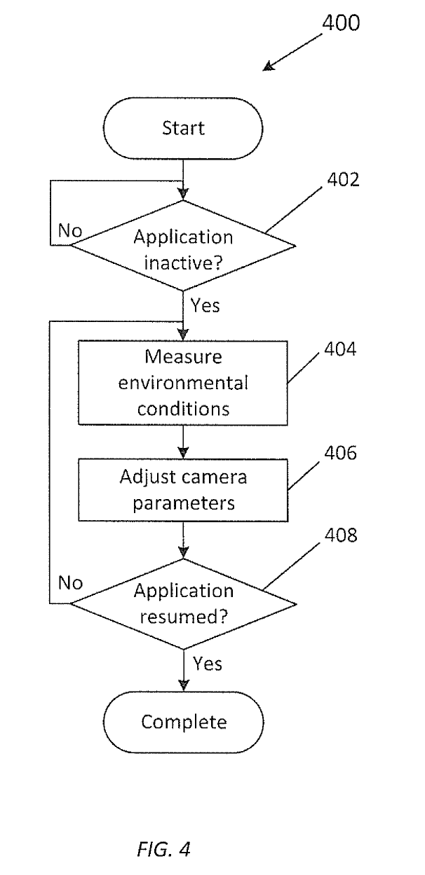

FIG. 4 is a flowchart illustrating a method for adjusting camera parameters during an inactive period according to one embodiment of the present invention. Referring to FIG. 4, the motion tracking engine 122 initially determines (402) whether the application 120 is in an inactive state, as described above (e.g., between rounds, paused, etc.). If the application is in an active state (e.g., actively detecting user input), then no adjustment is performed. If the application is in an inactive state, then the environmental conditions are measured (404) to determine, for example, the brightness of the ambient light, the distance to the subject, the color temperature of the scene, and the contrast between the detected objects (e.g., a hand) and the background. Parameters may be adjusted (406) based on the measured environmental conditions and one or more of the parameters may be supplied to the camera system 108. If the application has now been resumed, then the adjustment process ends. However, if the application has not been resumed, then the motion tracking engine 122 repeats the process of measuring the environmental conditions (404) and adjusting camera parameters (406) until the application is resumed, so that the parameters are properly for the conditions at the time that the application is resumed. In some embodiments, the adjustment process is delayed between cycles to reduce energy usage. In some embodiments, the adjustment process stops if the application 120 does not resume within a timeout period.

In some embodiments of the present invention, the adjustment of camera parameters is performed during an active period of the application 120. For example, adjustment may be performed between video capture frames or during a period in which the recalibration is substantially undetectable (e.g., immediately after detecting a correct capture). Performing adjustments during operation allows the motion detection engine 122 to adapt to changing environmental conditions while the user is playing the game, such as when the user moves out of direct sunlight and into a shaded area.

In several embodiments, the field of view of the camera can support multiplayer interactions with a video game. In certain embodiments, gestures that appear within different portions of the field of view of the camera system (e.g., left and right sides) are attributed to different controllable entities (e.g., players) within a video game, concurrently detected as separate gestures, and provided as different controller inputs to the video game application 120. In other embodiments, any of a variety of field of view, distance, and/or other properties of the captured video data can be utilized to assign a detected gesture to one or more players in a multiplayer video game as appropriate to the requirements of specific applications.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof. For example, the features and aspects described herein may be implemented independently, cooperatively or alternatively without deviating from the spirit of the disclosure.

For example, while the camera system 108 is disclosed as being rigidly attached to the video game system 100 or the video game controller 112, the term “rigidly attached” is intended to include situations where the camera system 108 (or one or more cameras thereof) may be repositioned, but remain substantially fixed in position during normal use (e.g., while playing the game). In addition, the term “rigidly attached” is also intended to include circumstances in which the camera system 108 (or one or more cameras thereof) may be controlled (e.g., by the processor) to pivot, zoom, or otherwise change its position during normal use.

Various functions embodiments of the present invention may be performed by different processors, such as the processor 102 of the video game system 100 and the processor 114 of the video game controller 112. For example, referring to FIGS. 1B and 2, in one embodiment of the present invention, the processor 102 of the video game system renders the user interface (202) and generates the silhouette (212) while the processor 114 of the video game controller 112 obtains the motion data (204), captures video data and detects gesture input (210), and detects motion input using the motion data (208).

What is claimed is:

1. A computing system comprising:
a camera system;
a motion sensor rigidly coupled to the camera system; and
a processor and memory, the memory storing instructions that, when executed by the processor, cause the processor to:
receive video data from the camera system;
detect a first gesture from the video data;
receive motion data from the motion sensor, the motion data corresponding to motion of the camera system;
determine whether the motion data exceeds a threshold;
cease detecting the first gesture from the video data when the motion data exceeds the threshold; and
supply the detected first gesture to an application as first input data when the motion data does not exceed the threshold.

2. The computing system of claim 1, wherein the memory further stores instructions that, when executed by the processor, cause the processor to:
supply the motion data as the first input data to the application when the motion data exceeds the threshold.

3. The computing system of claim 1, wherein the memory further stores instructions that, when executed by the processor, cause the processor to:
estimate background motion in accordance with the motion data; and
compensate the video data based on the motion data to generate compensated video data,
wherein the computing system is configured to detect the first gesture from the video data based on the compensated video data.

4. The computing system of claim 1, further comprising a display interface; and
wherein the memory further stores instructions that, when executed by the processor, cause the processor to display, via the display interface, a user interface, the user interface including a silhouette generated from the camera system, the silhouette representing the detected first gesture.

5. The computing system of claim 4, wherein the silhouette is blended with the user interface using alpha compositing.

6. The computing system of claim 4, wherein the silhouette comprises a plurality of silhouettes, each of the silhouettes corresponding to a portion video data captured at a different time.

7. The computing system of claim 1, wherein the memory further stores instructions that, when executed by the processor, cause the processor to:
cease detecting the first gesture when the application is inactive;
measure environmental conditions when the application is inactive; and
adjust parameters controlling the camera system when the application is inactive.

8. The computing system of claim 1, wherein the memory further stores instructions that, when executed by the processor, cause the processor to:
detect a second gesture from the video data concurrently with detecting the first gesture; and
supply the detected second gesture to the application as second input data.

9. The computing system of claim 8, wherein the silhouette comprises a plurality of silhouettes, a first silhouette of the silhouettes representing the detected first gesture and a second silhouette of the silhouettes representing the detected second gesture.

10. The computing system of claim 1, wherein the application is a video game.

11. A method for providing a user interface for a computing device, the method comprising:
receiving, by a processor, video data from a camera system;
detecting, by the processor, a first gesture from the video data;
receiving, by the processor, motion data from a motion sensor, the motion data corresponding to the motion of the camera system;
determining, by the processor, whether the motion data exceeds a threshold;
ceasing detection of the first gesture when the motion data exceeds the threshold; and
supplying, by the processor, the detected first gesture to an application as first input data when the motion data does not exceed the threshold.

12. The method of claim 11, further comprising:
supplying the motion data as the first input data to the application when the motion data exceeds the threshold.

13. The method of claim 11, further comprising:
estimating background motion in accordance with the motion data; and
compensating the video data based on the motion data to generate compensated video data,
wherein the detecting the first gesture from the video data is performed by detecting the first gesture from the compensated video data.

14. The method of claim 11, further comprising:
displaying, by the processor via a display interface, a user interface including a silhouette generated from the camera system, the silhouette representing the detected first gesture.

15. The method of claim 14, wherein the silhouette is blended with the user interface using alpha compositing.

16. The method of claim 14, wherein the silhouette comprises a plurality of silhouettes, each of the silhouettes corresponding to a portion of the video data captured at a different time.

17. The method of claim 11, further comprising:
ceasing detecting the first gesture when the application is inactive;
measuring environmental conditions when the application is inactive; and
adjusting parameters controlling the camera system when the application is inactive.

18. The method of claim 11, further comprising:
detecting a second gesture from the video data concurrently with detecting the first gesture from the video data; and
supplying the detected second gesture to the application as second input data.

19. The method of claim 18, wherein the silhouette comprises a plurality of silhouettes, a first silhouette of the silhouettes representing the detected first gesture and a second silhouette of the silhouettes representing the detected second gesture.

20. The method of claim 11, wherein the application is a video game.
